(19) United States
(12) Patent Application Publication
(10) Pub. No.: US 2023/0397530 A1
(43) Pub. Date: Dec. 14, 2023

(54) Method and System for Operating an Autonomous Mobile Green Area Maintenance Robot

(71) Applicant: Andreas Stihl AG & Co. KG, Waiblingen (DE)

(72) Inventors: Philip WOLF, Ebbs (AT); Markus GASSNER, Koessen (AT); Alexander RIEGER, Neubeuern (DE); Christian HORNGACHER, Kirchberg (AT); Peter RITZER, Ebbs (AT); Michael REITTER, Kufstein (AT); Alexander BIECHL, Kufstein (AT); Samuel ZOETTL, Kufstein (AT)

(21) Appl. No.: 18/208,462

(22) Filed: Jun. 12, 2023

(30) Foreign Application Priority Data
Jun. 13, 2022 (EP) 22178714.6

(51) Int. Cl. A01D 34/74; A01D 34/00

(52) U.S. Cl. CPC A01D 34/74; A01D 34/008; A01D 2101/00

(57) ABSTRACT

A method is provided for operating an autonomous mobile green area maintenance robot. The green area maintenance robot has a maintenance tool, wherein a maintenance height of the maintenance tool is adjustable. The method monitors whether a criterion for being stuck is satisfied, wherein the criterion for being stuck is characteristic of a contact part of the maintenance tool of the green area maintenance robot being stuck, and increases the maintenance height if the criterion for being stuck is satisfied.

### CROSS REFERENCE TO RELATED APPLICATION

This application claims priority under 35 U.S.C. § 119 from European Patent Application No. 22178714.6, filed Jun. 13, 2022, the entire disclosure of which is herein expressly incorporated by reference.

### BACKGROUND AND SUMMARY

The invention relates to a method and a system, in particular each, for operating an autonomous mobile green area maintenance robot.

The invention is based on the problem of providing a method and a system, in particular each, for operating an autonomous mobile green area maintenance robot which has improved properties.

The invention solves this problem by providing a method and a system as described in the independent claims. Advantageous developments and/or refinements of the invention are described in the dependent claims.

The method according to the invention is intended to operate an autonomous mobile green area maintenance robot. The green area maintenance robot has a maintenance tool. A maintenance height, in particular a value of the maintenance height, of the maintenance robot is adjustable. The method comprises the steps of: a) monitoring whether, in particular at least or only, one, in particular single, criterion for being stuck is satisfied. The criterion for being stuck is characteristic of, in particular a contact part of, in particular the maintenance tool of, the green area maintenance robot being stuck, in particular on an obstacle; and b) increasing the maintenance height if, in particular at least or only, the criterion for being stuck is satisfied.

This, in particular increasing the maintenance height, allows the condition of being stuck to be resolved and therefore allows the green area maintenance robot to be freed, in particular without a user.

In particular, the method, the operation, the monitoring process and the increasing process can be automatic.

The green area maintenance robot can be electric.

Autonomous mobile green area maintenance robot can mean that the green area maintenance robot can be designed to be moved automatically or independently or in a self-controlled manner and/or independently of the user, in particular on a green area that can be predefined and/or limited, and/or to perform maintenance, in particular to start and/or to stop the maintenance, in particular on the green area, automatically or independently or in a self-controlled manner and/or independently of the user.

The term “configured” can be used synonymously for the term “designed”.

The green area can be a meadow.

The maintenance tool can be designed to maintain the green area.

The contact part and/or the maintenance tool can be arranged on a bottom side of the green area maintenance robot.

Arranged can mean spatially arranged.

The term “comprises/comprise” or “includes/include” can be used synonymously for the term “has/have”.

The maintenance tool can be a cutting tool. In particular, the maintenance height can be a cutting height.

The term “tool height” can be used synonymously for the term “maintenance height”.

The green area maintenance robot can have or define a plane of travel, wherein the maintenance height can be above the plane of travel.

Adjustable can mean adjustable in three stages or continuously.

The term “identify” can be used synonymously for the term “monitor”.

The term “caught/become caught” or “trapped/become trapped” can be used synonymously for the term “stuck/become stuck”.

The criterion for being stuck can be predefined, in particular as a factory setting.

The criterion for being stuck can be a criterion for contact with an obstacle, wherein the criterion for contact with an obstacle can be characteristic of contact with an obstacle by, in particular the contact part of, in particular the maintenance tool of, the green area maintenance robot, in particular contact by way of or with the obstacle.

The obstacle can be a mound.

The term “contact element” can be used synonymously for the term “contact part”.

The term “identifying” can be used synonymously for the term “characteristic”.

The formulation “lifting the maintenance tool” can be used synonymously for the formulation “increasing the maintenance height”.

The maintenance height can be increased to a maximum.

If the criterion for being stuck is not, in particular no longer, satisfied, the maintenance height does not need to be or cannot be increased, and in particular can be reduced.

The monitoring and/or the increasing can be executed by means of the green area maintenance robot. In particular, the monitoring can be executed by means of, in particular at least, one, in particular electric, sensor of the green area maintenance robot. In addition or as an alternative, the increasing can be executed by means of an, in particular electric, height adjustment drive system of the green area maintenance robot. In particular, the sensor and the height adjustment drive system can be different, in particular independent of one another.

Step a) can be executed repeatedly and/or continuously, in particular several times.

Step b) can be executed after step a).

In one development of the invention, the green area maintenance robot has a locomotion mechanism, in particular a running gear. The locomotion mechanism is designed for locomotion, in particular propulsion, of the green area maintenance robot, in particular a locomotion direction. The contact part is designed to perform a monitoring movement, in particular counter to the locomotion direction, caused by the locomotion, in particular in the locomotion direction, and the condition of being stuck and is mounted movably, in particular displaceably, in relation to the locomotion mechanism. The criterion for being stuck is that the monitoring movement is caused, in particular with a minimum value or extent. This allows particularly good monitoring of the condition of being stuck. In particular, the locomotion mechanism can contain or define the plane of travel. In addition or as an alternative, the term “creates” can be used synonymously for the term “causes”. Further in addition or as an alternative, the formulation “with respect to” can be used synonymously for the term “in relation to”.

In one development of the invention, the green area maintenance robot has a locomotion drive system, in particular a propulsion drive system. The locomotion drive system is designed for, in particular driving, locomotion, in particular propulsion, of the green area maintenance robot, in particular on the green area. The criterion for being stuck is that, in spite of operation of the locomotion drive system, the green area maintenance robot is not moving, in particular traveling, as in the case when it is not stuck, in particular when it is freed from obstacles, in particular is not doing so at all. This allows particularly good monitoring of the condition of being stuck. In particular, the locomotion drive system can be electric and/or a motor drive system. In addition or as an alternative, the locomotion can be automatic. Further in addition or as an alternative, the term “operate” can be used synonymously for the term “operation”. Further in addition or as an alternative, “in spite of operation” can mean in spite of an, in particular maximum, drive torque of greater than zero and/or an, in particular maximum, drive current, which causes the drive torque, of greater than zero. Further in addition or as an alternative, “not moving, as in the case when it is not stuck” can mean moving, in particular at least two times, in particular at least four times, more slowly, in particular than a setpoint value or than expected. Further in addition or as an alternative, the sensor can be independent of the locomotion drive system.

In one refinement of the invention, monitoring or step a) comprises: sensing locomotion and/or lack of locomotion by means of determining a change and/or no change in distance, position and/or route of the green area maintenance robot and/or by means of magnetic field measurement, in particular global and/or local, position determination, in particular visual, odometry and/or inclination measurement and/or inertial navigation, in particular acceleration measurement and/or rate of rotation measurement. This allows particularly good monitoring of locomotion and/or lack of locomotion. In particular, the sensing process can be automatic. In addition or as an alternative, the term “detect” can be used synonymously for the term “sense”. Further in addition or as an alternative, the change in distance can be in relation to an, in particular immobile, object, such as a wall for example, and/or the determination of the change and/or no change in distance can be performed by means of ultrasound. Further in addition or as an alternative, the change in distance can be in relation to a boundary wire and/or the magnetic field measurement can be measurement of a magnetic field, in particular an amplitude and/or a phase of the magnetic field, caused by an electric current flowing through the boundary wire. Further in addition or as an alternative, the global position determination can be performed by means of a global navigation satellite system (GNSS). Further in addition or as an alternative, the term “inertia-based navigation” can be used synonymously for the term “inertial navigation”.

In one development of the invention, the maintenance tool is, in particular rotationally, movable, in particular for performing maintenance of the green area. Step b) comprises: stopping movement of the maintenance tool if, in particular at least or only, the criterion for being stuck is satisfied. In particular, the green area maintenance robot has a tool movement drive system. The tool movement drive system is designed for, in particular driving, the movement of the maintenance tool. Step b) comprises: stopping operation of the tool movement drive system if, in particular at least or only, the criterion for being stuck is satisfied. This allows the situation, in particular the condition of being stuck, to not be made worse and/or energy to be saved. In particular, the maintenance tool can be designed for movement, in particular for rotation, substantially or approximately, in particular exactly, parallel to the plane of travel. In addition or as an alternative, the stopping process can be automatic. Further in addition or as an alternative, the term “deactivate” or “switch off” can be used synonymously for the term “stop”. Further in addition or as an alternative, the tool movement drive system can be electric and/or a motor drive system. Further in addition or as an alternative, the movement does not need to be or cannot be stopped, in particular can be started, if the criterion for being stuck is not, in particular no longer, satisfied.

In one development, in particular one refinement, of the invention, the green area maintenance robot has a locomotion drive system, in particular a propulsion drive system. The locomotion drive system is designed for, in particular driving, locomotion, in particular propulsion, of the green area maintenance robot, in particular on the green area. Step b) comprises: operating the locomotion drive system to move the green area maintenance robot, in particular in an averted, in particular opposite, locomotion direction, in particular after the maintenance height has been increased, in particular and after the movement of the maintenance tool has been stopped, in particular after the operation of the tool movement drive system has been stopped. In particular, the method comprises the step of: reducing the maintenance height, in particular and starting the movement of the maintenance tool, in particular starting the operation of the tool movement drive system, after step b), in particular if, in particular at least or only, one, in particular single, reversion criterion is satisfied. This, in particular the operation of the locomotion drive system, allows the condition of being stuck to be resolved and/or prevents the situation of becoming stuck occurring again. In particular, the locomotion drive system can be electric and/or a motor drive system. In addition or as an alternative, the locomotion, the operation, the reducing process and/or the starting process can be automatic. Further in addition or as an alternative, the locomotion direction can be averted, in particular opposite, to a locomotion direction before the criterion for being stuck is satisfied. Further in addition or as an alternative, step b) can comprise: operating the locomotion drive system to turn the green area maintenance robot in the averted, in particular opposite, locomotion direction. Further in addition or as an alternative, the green area maintenance robot can have at least one driven running wheel and at least one non-driven running wheel for propulsion of the green area maintenance robot, in particular on the green area. At least the non-driven running wheel can be arranged in front of at least the driven running wheel in the locomotion direction. In particular, it can be arranged at the front in a preferred or main movement direction of the green area maintenance robot. Further in addition or as an alternative, the locomotion in the locomotion direction can be a forward movement. Further in addition or as an alternative, the green area maintenance robot does not need to be or cannot be moved in the averted, in particular opposite, locomotion direction if the criterion for being stuck is not satisfied. Further in addition or as an alternative, the reversion criterion can be predefined, in particular as a factory setting. Further in addition or as an alternative, the reversion criterion can be that the criterion of being stuck is not satisfied, in particular for a minimum time period. Further in addition or as an alternative, the reversion criterion can be a situation of a minimum locomotion time period and/or a minimum locomotion route for the locomotion being reached and/or exceeded. In particular, the minimum locomotion time period and/or the minimum locomotion route can be dependent on an extent of the green area maintenance robot in the locomotion direction. Further in addition or as an alternative, the maintenance height can be reduced to a value such as that before the criterion for being stuck was satisfied. Further in addition or as an alternative, the formulation “lowering the maintenance tool” can be used synonymously for the formulation “reducing the maintenance height”. Further in addition or as an alternative, the term “activate” or “switch on” can be used synonymously for the term “start”.

In one development, in particular one refinement, of the invention, the green area maintenance robot has a protection device. The protection device is designed to protect against access into the maintenance tool, in particular by the user. The protection device has the contact part, in particular is the contact part. In addition or as an alternative, a protection height, in particular a value of the protection height, of the protection device is adjustable. Step b) comprises: increasing the protection height if, in particular at least or only, the criterion for being stuck is satisfied. In particular, the method comprises the step of: reducing the protection height after step b), in particular if, in particular at least or only, the reversion criterion is satisfied. This, in particular increasing the protection height, allows the condition of being stuck to be resolved. In particular, the increasing process and/or the reducing process can be automatic. In addition or as an alternative, the protection height can be increased to a maximum. Further in addition or as an alternative, the protection height cannot or need not be increased, in particular can be reduced, if the criterion for being stuck is not, in particular is no longer, satisfied. Further in addition or as an alternative, the protection height can be reduced to a value such as that before the criterion for being stuck was satisfied. Further in addition or as an alternative, the protection height can be above the plane of travel. Further in addition or as an alternative, the protection device can have, in particular be, an, in particular downwardly oriented and/or downwardly open, comb and/or cage. In particular, the protection height can be a comb and/or cage height, in particular of a bottom edge, of the comb and/or cage. Further in addition or as an alternative, the protection device can have, in particular be, an, in particular downwardly oriented and/or downwardly open, tool housing, in particular a cutting deck housing. In particular, the protection height can be a tool housing height, in particular of a bottom edge, of the tool housing.

In one development, in particular one refinement, of the invention, the maintenance height and/or the protection height are/is adjustable in a range of from 0 cm (centimeter), in particular 2.5 cm, in particular 5 cm, to 20 cm, in particular 15 cm, in particular 10 cm, in particular from the green area and/or the plane of travel.

In one development, in particular one refinement, of the invention, the green area maintenance robot is designed in such a way that the adjustment of the maintenance height and/or the protection height are/is independent of locomotion of the green area maintenance robot. In particular, the green area maintenance robot has a locomotion drive system, in particular a propulsion drive system. The locomotion drive system is designed for, in particular driving, locomotion, in particular propulsion, of the green area maintenance robot, in particular on the green area. The green area maintenance robot has a height adjustment drive system. The height adjustment drive system is designed to adjust the maintenance height and/or the protection height. The height adjustment drive system is independent of the locomotion drive system. In particular, the adjustment does not need to be or cannot be caused by the locomotion. In addition or as an alternative, the locomotion drive system and the height adjustment drive system can be electric and/or a motor drive system.

In one development, in particular one refinement, of the invention, the contact part and/or the protection device are/is arranged in front of the maintenance tool.

in one development, in particular one refinement, of the invention, the green area maintenance robot has a locomotion frame, in particular an undercarriage, and/or a covering hood. In particular, the locomotion frame and/or the covering hood, in particular by way of a part in front of the contact part and/or the maintenance tool and/or the protection device, are/is arranged above the contact part and/or the maintenance tool and/or the protection device. The maintenance height and/or the protection height are/is adjustable in relation to the locomotion frame and/or the covering hood. In addition or as an alternative, the locomotion frame and/or the covering hood are/is different from the contact part. This allows protection against access into the maintenance tool to be maintained by means of the locomotion frame and/or the covering hood. In particular, the term “chassis” can be used synonymously for the term “undercarriage”. In addition or as an alternative, the term “protection hood” can be used synonymously for the term “covering hood”. Further in addition or as an alternative, the contact part and/or the maintenance tool and/or the protection device can be arranged on a bottom side of the locomotion frame and/or the covering hood. Further in addition or as an alternative, a height of the locomotion frame and/or a height of the covering hood do/does not need to be or cannot be adjustable.

In one development, in particular one refinement, of the invention, the green area maintenance robot has a locomotion mechanism, in particular a running gear, and a covering hood. The locomotion mechanism is designed for locomotion, in particular propulsion, of the green area maintenance robot, in particular in a locomotion direction. The covering hood is designed to perform a hood movement, in particular against the locomotion direction, caused by the locomotion, in particular in the locomotion direction, and contact with the hood and is mounted movably, in particular displaceably, in relation to the locomotion mechanism. The method comprises the steps of: monitoring whether, in particular at least or only, one, in particular single, hood movement criterion is satisfied. The hood movement criterion is that the hood movement has been caused, in particular with a minimum value or extent. Moving the green area maintenance robot in an averted, in particular opposite, locomotion direction, in particular and not increasing the maintenance height, if, in particular at least or only, the hood movement criterion is satisfied. This allows a distinction to be drawn between the condition of being stuck, such as on a mound for example, and collision, such as against a wall for example, and therefore allows different or various actions. In particular, the hood movement can be different from the monitoring movement. In addition or as an alternative, the contact with the hood can be different from the condition of being stuck, in particular contact with an obstacle. Further in addition or as an alternative, the hood movement criterion can be different from the criterion for being stuck, in particular the criterion for contact with an obstacle. Further in addition or as an alternative, the hood movement criterion can be predefined, in particular as a factory setting. Further in addition or as an alternative, the monitoring process and/or the locomotion can be automatic. Further in addition or as an alternative, the movement of the maintenance tool does not have to be or cannot be stopped if the hood movement criterion is satisfied. Further in addition or as an alternative, the green area maintenance robot does not need to be or cannot be moved in an averted, in particular opposite, locomotion direction if the hood movement criterion is not satisfied.

In one development of the invention, the green area maintenance robot is a lawnmowing robot. In addition or as an alternative, the maintenance tool has a lawnmowing tool, in particular is the lawnmowing tool. In addition or as an alternative, the maintenance height is a lawnmowing height. The method can be particularly advantageous for a green area maintenance robot of this kind. In particular, the green area maintenance robot can be a mulching mowing robot. In addition or as an alternative, the lawnmowing tool can comprise at least one mowing line, at least one plastic blade, at least one metal blade and/or a metal cutting blade with at least one cutting edge and/or with at least one cutting tooth. Further in addition or as an alternative, the lawnmowing tool can be designed as a rotating lawnmowing tool and to mow a material to be mowed using a so-called free-cutting method without a counter blade. Further in addition or as an alternative, the lawnmowing tool can be designed for mowing the green area. Further in addition or as an alternative, the green area can be a lawn.

The system according to the invention is a system for operating an, in particular the, autonomous mobile green area maintenance robot. The green area maintenance robot has a, in particular the, maintenance tool. An, in particular the, maintenance height of the maintenance tool is adjustable. The system has a monitoring device and a height adjustment device, in particular and the green area maintenance robot. The monitoring device is designed to monitor whether an, in particular the, criterion for being stuck is satisfied. The criterion for being stuck is characteristic of, in particular an, in particular the, contact part of, in particular the maintenance tool of, the green area maintenance robot being stuck. The height adjustment device is designed to increase the maintenance height if the criterion for being stuck is satisfied. In particular, the green area maintenance robot has the monitoring device and/or the height adjustment device.

The system can render possible the same advantage/advantages as mentioned above for the method.

In particular, the system can be used for, in particular automatically, executing an, in particular the, method as mentioned above. In addition or as an alternative, the system can be a green area maintenance system. Further in addition or as an alternative, the system, the monitoring device and/or the height adjustment device can be electric and/or have the sensor and/or a computing device and/or a processor and/or a microcontroller and/or a memory device and/or a computer. Further in addition or as an alternative, the green area maintenance robot can be designed as mentioned above for the method.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows a perspective view of a system according to an embodiment of the invention having an autonomous mobile green area maintenance robot having a maintenance tool;

FIG. 2 shows a sectioned side view of the system of FIG. 1 and an exemplary method according to the invention for operating the autonomous mobile green area maintenance robot;

FIG. 3 shows a sectioned side view of the system of FIG. 1 and of the method of FIG. 2 when monitoring for a condition of the green area maintenance robot being stuck;

FIG. 4 shows a sectioned side view of the system of FIG. 1 and of the method of FIG. 2 when increasing a maintenance height of the maintenance tool;

FIG. 5 shows a plan view of the system of FIG. 1 and of the method of FIG. 2 when moving in an averted locomotion direction of the green area maintenance robot;

FIG. 6 shows a sectioned side view of the system of FIG. 1 and the method of FIG. 2 when reducing the maintenance height; and

FIG. 7 shows a side view of the system of FIG. 1 and the method of FIG. 2 when monitoring a hood movement and when moving in an averted locomotion direction of the green area maintenance robot.

### DETAILED DESCRIPTION OF THE DRAWINGS

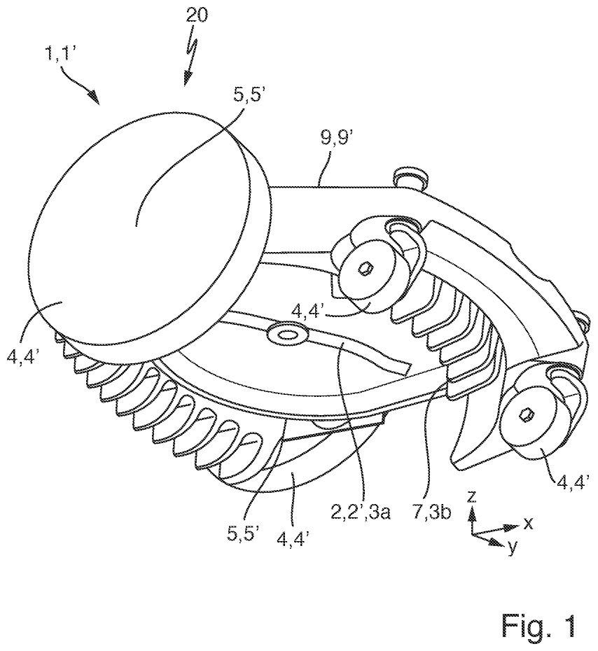

FIGS. 1 to 7 show a system 20 and a method for operating an autonomous mobile green area maintenance robot 1.

The green area maintenance robot 1 has a maintenance tool 2. A maintenance height 2H of the maintenance tool 2 is adjustable.

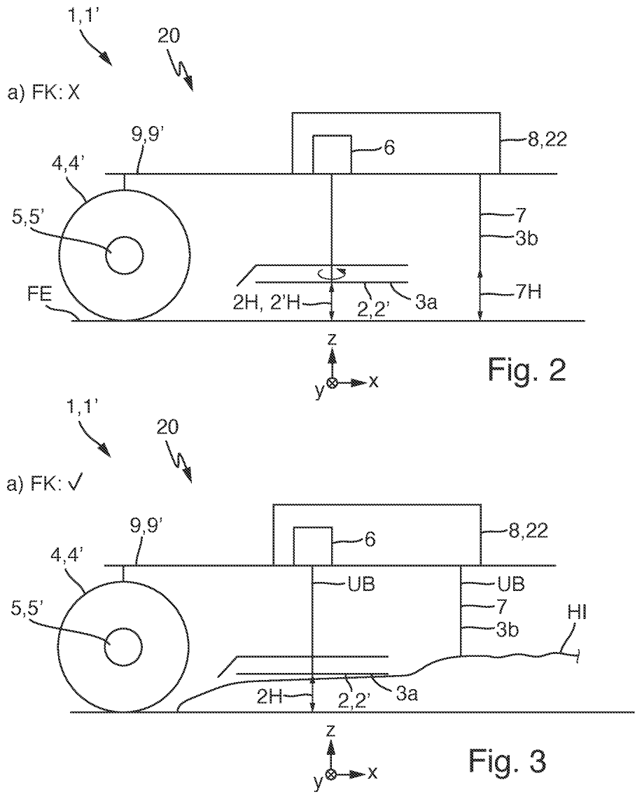

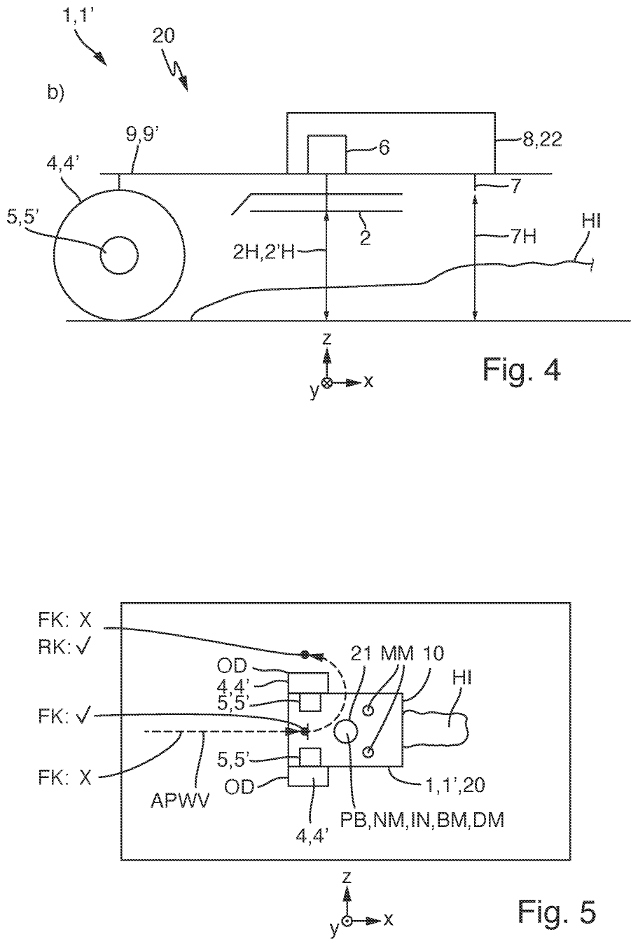

The system 20 has a monitoring device 21 and a height adjustment device 22, in particular and the green maintenance robot 1. The monitoring device 21 is designed to monitor, in particular monitors, whether a criterion for being stuck FK is satisfied, as shown in FIG. 2. The criterion for being stuck FK is characteristic of, in particular a contact part 3a, 3b of, in particular the maintenance tool 2 of, the green area maintenance robot 1 being stuck, in particular on an obstacle HI, as shown in FIG. 3. The height adjustment device 22 is designed to increase, in particular increases, the maintenance height 2H if the criterion for being stuck FK is satisfied, as shown in FIG. 4. In particular, the green area maintenance robot 1 has the monitoring device 21 and/or the height adjustment device 22.

The method comprises the steps of: a) monitoring whether the criterion for being stuck FK is satisfied, in particular by means of the monitoring device 21, and b) increasing the maintenance height 2H, in particular by means of the height adjustment device 22, if the criterion for being stuck FK is satisfied.

In particular, the green area maintenance robot 1 has a plane of travel FE, wherein the maintenance height 2H is above the plane of travel FE.

Specifically, the green area maintenance robot 1 has a locomotion mechanism 4, in particular a running gear 4′. The locomotion mechanism 4 is designed for locomotion, in particular propulsion, of, in particular moves, the green area maintenance robot 1.

Furthermore, the contact part 3a, 3b is designed to perform a monitoring movement UB caused by the locomotion and the condition of being stuck and is mounted movably in relation to the locomotion mechanism 4. The criterion for being stuck FK is that the monitoring movement UB is caused, as shown in FIG. 3.

In addition, the green area maintenance robot 1 has a locomotion drive system 5, in particular a propulsion drive system 5′. The locomotion drive system 5 is designed for locomotion, in particular propulsion, of, in particular moves, the green area maintenance robot 1.

Furthermore, the criterion for being stuck FK is that, in spite of operation of the locomotion drive system 5, the green area maintenance robot 1 is not moving, in particular traveling, as in the case when it is not stuck, in particular is not doing so at all, as shown in FIG. 3.

Specifically, monitoring comprises: sensing locomotion by means of determining a change or no change in distance, position and/or route APBW of the green area maintenance robot 1 and/or by means of magnetic field measurement MM, in particular global and/or local, position determination PB, in particular visual, odometry OD and/or inclination measurement NM and/or inertial navigation IN, in particular acceleration measurement BM and/or rate of rotation measurement DM, in particular by means of the monitoring device 21.

In addition, the maintenance tool 2 is, in particular rotationally, movable. Step b) comprises: stopping movement of the maintenance tool 2 if the criterion for being stuck FK is satisfied, as shown in FIG. 4. In particular, the green area maintenance robot 1 has a tool movement drive system 6. The tool movement drive system 6 is designed for moving, in particular moves, the maintenance tool 2. Step b) comprises: stopping operation of the tool movement drive system 6 if the criterion for being stuck FK is satisfied.

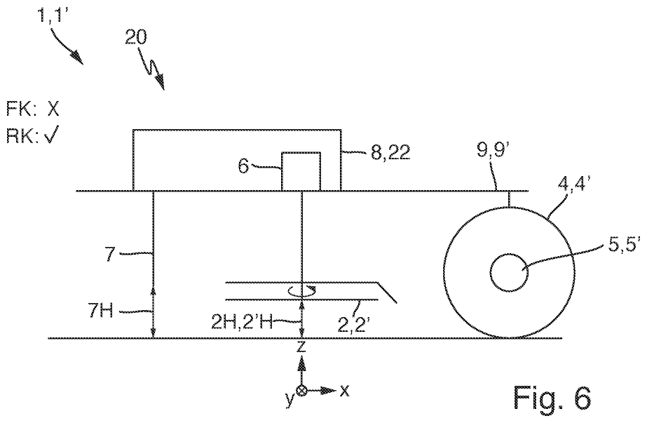

Furthermore, step b) comprises: operating the locomotion drive system 5 to move the green area maintenance robot 1, in particular in an averted, in particular opposite, locomotion direction −x, in particular after the maintenance height 2H has been increased, in particular and after the movement of the maintenance tool 2 has been stopped, in particular after the operation of the tool movement drive system 6 has been stopped, as shown in FIG. 5. In particular, the method comprises the step of: reducing the maintenance height 2H, in particular by means of the height adjustment device 22, in particular and starting the movement of the maintenance tool 2, in particular starting the operation of the tool movement drive system 6, after step b), in particular if a reversion criterion RK is satisfied, as shown in FIG. 6.

In addition, the green area maintenance robot 1 has a protection device 7. The protection device 7 is designed to protect against access into the maintenance tool 2. The protection device 7 has the contact part 3b, in particular is the contact part 3b. In addition or as an alternative, a protection height 7H of the protection device 7 is adjustable. Step b) comprises: increasing the protection height 7H, in particular by means of the height adjustment device 22, if the criterion for being stuck FK is satisfied, as shown in FIG. 4. In particular, the method comprises the step of: reducing the protection height 7H, in particular by means of the height adjustment device 22, after step b), as shown in FIG. 6.

Specifically, the maintenance height 2H and/or the protection height 7H are/is adjustable in a range of from 0 cm, in particular 2.5 cm, in particular 5 cm, to 20 cm, in particular 15 cm, in particular 10 cm.

Furthermore, the green area maintenance robot 1 is designed in such a way that the adjustment of the maintenance height 2H and/or the protection height 7H is independent of locomotion of the green area maintenance robot 1. In particular, the green area maintenance robot 1 has a height adjustment drive system 8. The height adjustment drive system 8 is designed to adjust, in particular adjusts, the maintenance height 2H and/or the protection height 7H. The height adjustment drive system 8 is independent of the locomotion drive system 5.

In addition, the contact part 3b and/or the protection device 7 are/is arranged in front of the maintenance tool 2.

Furthermore, the green area maintenance robot 1 has a locomotion frame 9, in particular an undercarriage 9′, and/or a covering hood 10. In particular, the locomotion frame 9 and/or the covering hood 10 are/is arranged above the contact part 3a, 3b and/or the maintenance tool 2 and/or the protection device 7. The maintenance height 2H and/or the protection height 7H are/is adjustable in relation to the locomotion frame 9 and/or the covering hood 10. In addition or as an alternative, the locomotion frame 9 and/or the covering hood 10 are/is different from the contact part 3a, 3b.

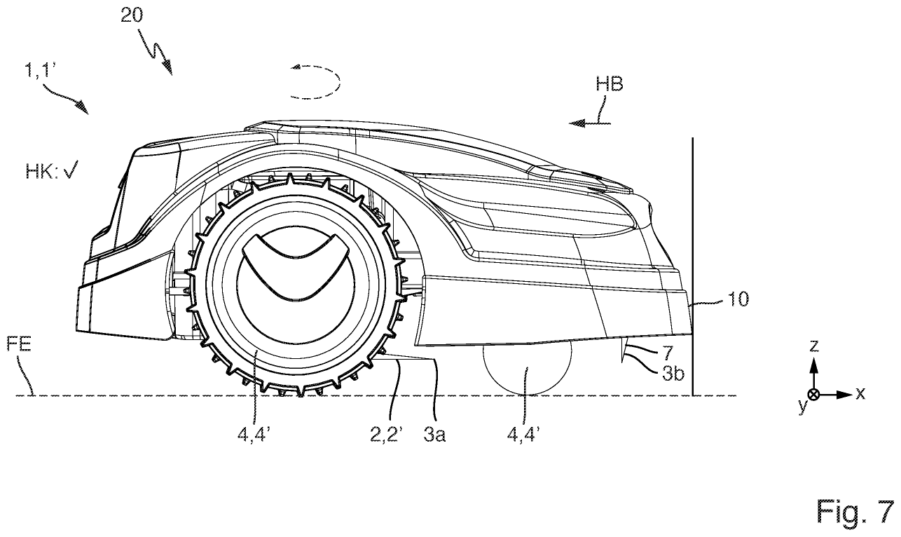

In addition, the covering hood 10 is designed to perform a hood movement HB caused by the locomotion and contact with the hood and is mounted movably in relation to the locomotion mechanism 4. The method comprises the steps of: monitoring whether a hood movement criterion HK is satisfied, in particular by means of the monitoring device 21. The hood movement criterion HK is that the hood movement HB has been caused, as shown in FIG. 7; and moving the green area maintenance robot 1 in an averted, in particular opposite, locomotion direction −x, in particular and not increasing the maintenance height 2H, if the hood movement criterion HK is satisfied.

Specifically, the green area maintenance robot 1 is a lawnmowing robot 1′. In addition or as an alternative, the maintenance tool 2 has a lawnmowing tool 2′, in particular is the lawnmowing tool 2′. Further in addition or as an alternative, the maintenance height 2H is a lawnmowing height 2′H.

As is clear from the exemplary embodiments shown and explained above, the invention provides an advantageous method and an advantageous system, in particular each, for operating an autonomous mobile green area maintenance robot, which has improved properties.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for operating an autonomous mobile green area maintenance robot having a maintenance tool, wherein a maintenance height of the maintenance tool is adjustable, the method comprising the steps of:
a) monitoring whether a criterion for being stuck is satisfied, wherein the criterion for being stuck is characteristic of a contact part of the maintenance tool of the green area maintenance robot being stuck; and
b) increasing the maintenance height when the criterion for being stuck is satisfied.

2. The method according to claim 1,
wherein the green area maintenance robot has a locomotion mechanism designed for locomotion of the green area maintenance robot,
wherein the contact part is designed to perform a monitoring movement caused by the locomotion and the condition of being stuck and is mounted movably in relation to the locomotion mechanism, and
wherein the criterion for being stuck is that the monitoring movement is caused.

3. The method according to claim 1,
wherein the green area maintenance robot has a locomotion drive system designed for locomotion of the green area maintenance robot, and
wherein the criterion for being stuck is that, in spite of operation of the locomotion drive system, the green area maintenance robot is not moving as in the case when it is not stuck.

4. The method according to claim 3, wherein the monitoring comprises:
sensing locomotion by way of determining a change in distance, position and/or route of the green area maintenance robot and/or by way of magnetic field measurement.

5. The method according to claim 4, wherein the monitoring comprises global and/or local, position determination, including visual, odometry and/or inclination measurement and/or inertial navigation, including acceleration measurement and/or rate of rotation measurement.

6. The method according to claim 1,
wherein the maintenance tool is rotationally movable, and
wherein step b) comprises stopping the movement of the maintenance tool when the criterion for being stuck is satisfied.

7. The method according to claim 6,
wherein the green area maintenance robot has a tool movement drive system,
wherein the tool movement drive system is designed for moving the maintenance tool, and
wherein step b) comprises stopping operation of the tool movement drive system when the criterion for being stuck is satisfied.

8. The method according to claim 7,
wherein the green area maintenance robot has a locomotion drive system,
wherein the locomotion drive system is designed for locomotion of the green area maintenance robot, and
wherein step b) comprises operating the locomotion drive system to move the green area maintenance robot in an averted locomotion direction after the maintenance height has been increased, and after the movement of the maintenance tool has been stopped.

9. The method according to claim 8, wherein the method comprises the step of:
reducing the maintenance height and starting the movement of the maintenance tool after step b) when a reversion criterion is satisfied.

10. The method according to claim 1,
wherein the green area maintenance robot has a protection device designed to protect against access into the maintenance tool,
wherein the protection device has the contact part, and/or
wherein a protection height of the protection device is adjustable, and wherein step b) comprises increasing the protection height when the criterion for being stuck is satisfied, and wherein the method comprises the step of reducing the protection height after step b).

11. The method according to claim 10,
wherein the maintenance height and/or the protection height are/is adjustable in a range of from 0 cm to 20 cm.

12. The method according to claim 10,
wherein the green area maintenance robot is designed such that the adjustment of the maintenance height and/or the protection height are/is independent of locomotion of the green area maintenance robot.

13. The method according to claim 12,
wherein the green area maintenance robot has a locomotion drive system designed for locomotion of the green area maintenance robot,
wherein the green area maintenance robot has a height adjustment drive system designed to adjust the maintenance height and/or the protection height, and
wherein the height adjustment drive system is independent of the locomotion drive system.

14. The method according to claim 10,
wherein the contact part and/or the protection device are/is arranged in front of the maintenance tool.

15. The method according to claim 10,
wherein the green area maintenance robot has a locomotion frame and/or a covering hood,
wherein the locomotion frame and/or the covering hood are/is arranged above the contact part and/or the maintenance tool and/or the protection device, and
wherein the maintenance height and/or the protection height are/is adjustable in relation to the locomotion frame and/or the covering hood, and/or
wherein the locomotion frame and/or the covering hood are/is different from the contact part.

16. The method according to claim 15,
wherein the green area maintenance robot has a locomotion mechanism and the covering hood,
wherein the locomotion mechanism is designed for locomotion of the green area maintenance robot, and
wherein the covering hood is designed to perform a hood movement caused by the locomotion and contact with the hood and is mounted movably in relation to the locomotion mechanism,
wherein the method further comprises the steps of:
monitoring whether a hood movement criterion is satisfied, wherein the hood movement criterion is that the hood movement has been caused, and
moving the green area maintenance robot in an averted locomotion direction and not increasing the maintenance height, when the hood movement criterion is satisfied.

17. The method according to claim 1,
wherein the green area maintenance robot is a lawnmowing robot, and/or
wherein the maintenance tool has a lawnmowing tool, and/or
wherein the maintenance height is a lawnmowing height.

18. A system for operating an autonomous mobile green area maintenance robot having a maintenance tool, wherein a maintenance height of the maintenance tool is adjustable, the system comprising:
a monitoring device, wherein the monitoring device is designed to monitor whether a criterion for being stuck is satisfied, wherein the criterion for being stuck is characteristic of a contact part of the maintenance tool of the green area maintenance robot being stuck; and
a height adjustment device, wherein the height adjustment device is designed to increase the maintenance height when the criterion for being stuck is satisfied.

19. The system according to claim 18, wherein the green area maintenance robot has the monitoring device and/or the height adjustment device.
